(19) United States
(12) Patent Application Publication
(10) Pub. No.: US 2017/0344770 A1
(43) Pub. Date: Nov. 30, 2017

(54) RFID TAG

(71) Applicant: TOSHIBA TEC KABUSHIKI KAISHA, Tokyo (JP)

(72) Inventors: Sadatoshi Oishi, Fuji Shizuoka (JP); Sunao Tsuchida, Mishima Shizuoka (JP)

(21) Appl. No.: 15/592,460

(22) Filed: May 11, 2017

(30) Foreign Application Priority Data
May 31, 2016 (JP) 2016-108653

(51) Int. Cl. G06K 7/10

(52) U.S. Cl. CPC G06K 7/10366

(57) ABSTRACT

An RFID tag of one embodiment includes an RFID tag main body, in which an RFID chip and an antenna are disposed on a base material, and a retro-reflective material mounted on the RFID tag main body.

### CROSS-REFERENCE TO RELATED APPLICATIONS

This application is based upon and claims the benefit of priority from Japanese Patent Application No. P2016-108653, filed May 31, 2016, the entire contents of which are incorporated herein by reference.

### FIELD

Embodiments relate generally to an RFID tag, an RFID system, and methods related thereto.

### BACKGROUND

Recently, the physical infrastructure of society such as bridges or tunnels are deteriorating and thus efficient maintenance is needed. In general, a provider for performing inspection inspects the state of an inspection place such as a bridge or a tunnel. In this case, marking is performed on a site for which it is determined that mending is needed by chalk or the like and contents of repairs are recorded in a plan. Thereafter, a contractor for performing repair searches for a marked site of the inspection place while referencing the plan having the contents recorded therein and checks the contents of repairs.

However, the inside of a bridge or a tunnel is dark and same structures are often consecutive and thus it is difficult to search for the site marked by chalk or the like.

Here, a radio frequency identifier (RFID) tag and an article recognition system using the RFID tag are known. However, an RFID tag communication device capable of being used outdoors is restricted to a specific low power wireless station and thus a reading range of the RFID tag is limited to about 2 to 3 meters. For that reason, when it is not practical to make an RFID reader approach positions near the RFID tag, it becomes unable to read information of the RFID tag. Accordingly, when a search area is wider than a search range of the specific low power wireless station, work for searching for a position of a target RFID tag using the RFID reader to check an inspection site is difficult and time consuming.

A tag in which a color sheet layer is laminated on a retro-reflective layer obtained by laminating a retro-reflective material layer onto a support layer may be used. Here, the color sheet layer is transparent and color code information coded by a color within a visible light range is printed on the color sheet layer. Accordingly, tags which are capable of being recognized even in a dark site, even from a distant place, and even when the tags are attached to a curved site and capable of being recognized even when the plurality of tags are adjacently disposed are provided.

However, in a case of a tag in which color code information is printed, when the tag is left outdoors for a long time, weathering occurs, dusts are accumulated, and thus it becomes difficult to accurately read color code information.

### DESCRIPTION OF THE DRAWINGS

FIG. 1 is an exploded perspective view of an RFID tag according to a first embodiment.

FIG. 2 is a perspective view of the RFID tag according to the first embodiment.

FIG. 3 is a perspective view for explaining a use state of a portable inspection place search device which is used when searching an inspection place such as a bridge or a tunnel by being combined with the RFID tag according to the first embodiment.

FIG. 4 is a perspective view illustrating a modification example of the RFID tag according to the first embodiment.

FIG. 5 is a perspective view illustrating an example of a display unit of the inspection place search device of the first embodiment.

FIG. 6 is a block diagram illustrating an electrical configuration of the inspection place search device illustrated in FIG. 5.

FIG. 7 is a diagram illustrating an example of place data.

FIG. 8 is a diagram illustrating an example of association data.

FIG. 9 is a perspective view illustrating an RFID tag according to a second embodiment.

FIG. 10 is a plan view illustrating an example of a retro-reflective portion of the RFID tag according to the second embodiment.

FIG. 11 is a perspective view of an RFID tag according to a third embodiment.

FIG. 12 is a plan view illustrating an example of a retro-reflective portion of the RFID tag according to the third embodiment.

FIG. 13 is a perspective view for explaining a use state of an RFID tag according to a fourth embodiment.

### DETAILED DESCRIPTION

A problem to be solved by the present embodiment is to provide an RFID tag which is attached to an inspection site and is capable of being efficiently searched for, and from which necessary information is capable of being acquired, when the inspection site is checked while referencing a plan within a metal structure such as a plate girder bridge.

An RFID tag of one embodiment includes an RFID tag main body, in which an RFID chip and an antenna are disposed on a base material, and a retro-reflective material mounted on the RFID tag main body.

In the following, embodiments will be described with reference to the accompanying drawings.

### First Embodiment

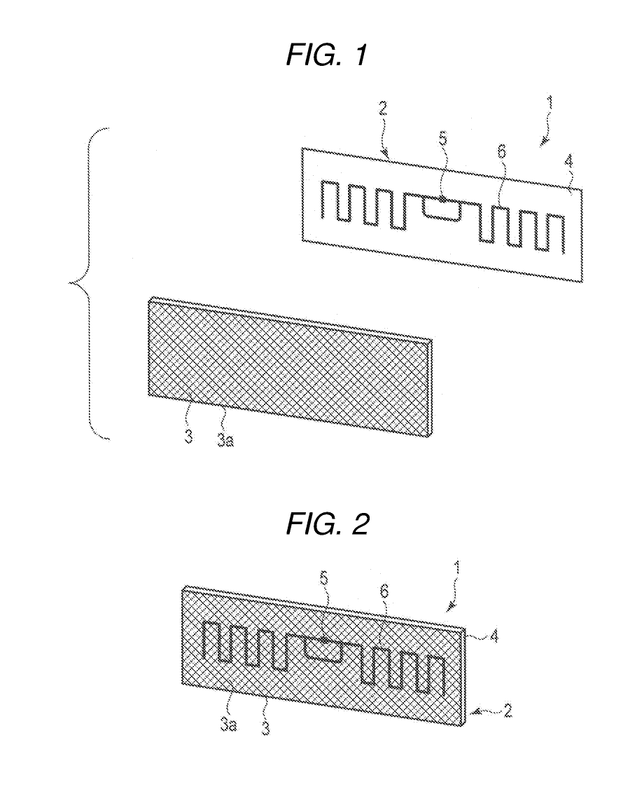

FIG. 1 is an exploded perspective view of an RFID tag 1 according to a first embodiment. FIG. 2 is a perspective view of the RFID tag 1 according to the first embodiment. As illustrated in FIG. 1, the RFID tag 1 of the present embodiment includes a plate shaped RFID tag main body 2 and a plate shaped retro-reflective material 3 mounted on the RFID tag main body 2. In the RFID tag main body 2, an RFID chip 5 and an antenna 6 are disposed on a plate shaped holding member (sheet base material) 4. In the present embodiment, as illustrated in FIG. 2, the retro-reflective material 3 is integrated with the RFID tag main body 2 by being disposed to be superposed and laminated on a surface of the RFID tag main body 2. Accordingly, although the antenna 6 is not seen from a reflecting surface 3a side of the retro-reflective material 3, as illustrated FIG. 2, the RFID chip 5 and the antenna 6 are displayed on the reflecting surface 3a side in a superposing manner for explanation.

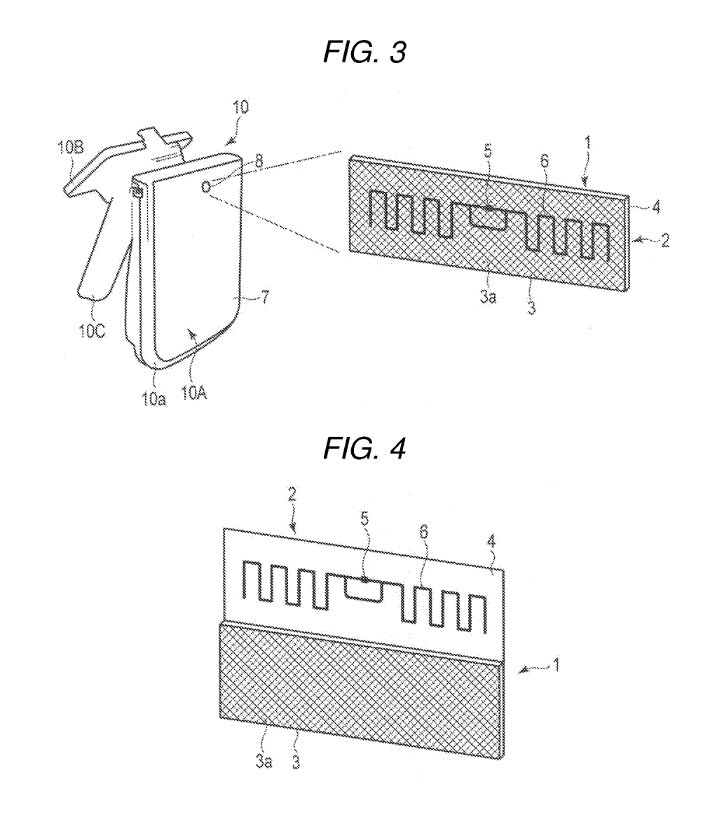

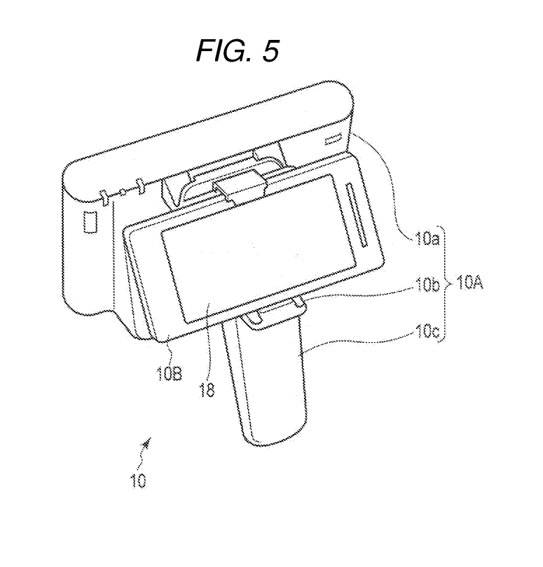

Next, a method for finding a target tag by attaching the RFID tag 1 with the retro-reflective material 3 of the present embodiment to a structure such as a plate girder bridge (abut bridge) will be described. The RFID tag 1 of the present embodiment is used by being attached to the structure such as the plate girder bridge by the provider who performs inspection. When the RFID tag 1 is intended to be attached to a metal structure, the RFID tag 1 is fixed by an adhesive tape with a spacer such as styrene foam held between the RFID tag 1 and the metal structure (not illustrated). This is because when the antenna 6 approaches metal, the antenna 6 does not function as an antenna. Furthermore, the RFID tag 1 capable of being attached to a metallic surface and the retro-reflective material 3 may be combined. In general, inspection places such as a bridge or a tunnel are present at a plurality of sites in a wide range and the RFID tag 1 is attached to each of the plurality of inspection places. In this case, when the RFID tag 1 is attached, data which is obtained by associating marking data, a photograph of the part thereof, records repair contents, or the like of the site, for which it is determined that mending is needed, with one another is recorded at the same time using a portable inspection place search device 10 illustrated in FIG. 3 and FIG. 5. When the RFID tag 1 is attached to the metal structure, a configuration in which the RFID tag 1 is attached to a magnet may be adopted.

A position of the RFID tag 1 of the present embodiment is searched during work such as mending of the inspection place such as a bridge or a tunnel, by using the portable inspection place search device 10 illustrated in FIG. 3 and FIG. 5. The inspection place search device 10 includes a communication unit 10A and a portable information terminal 10B. FIG. 3 is a perspective view illustrating appearance when viewed from the communication unit 10A side of the inspection place search device 10. FIG. 5 is a perspective view illustrating a display screen 18 at the portable information terminal 10B side of the inspection place search device 10 of the inspection place search device 10.

The communication unit 10A includes a unit main body 10a, a holder 10b, and a grip 10c. The unit main body 10a accommodates most of electrical constituents which will be described later therein and an RFID reader 7, a light for illumination (light source) 8 are incorporated therein. The holder 10b detachably holds the portable information terminal 10B. The grip 10c is gripped by a user of the inspection place search device 10.

The portable information terminal 10B performs information processing for supporting search, which will be described later, while performing wireless communication with the communication unit 10A. As the portable information terminal 10B, for example a mobile phone, a smart phone, tablet type computer, or the like can be utilized.

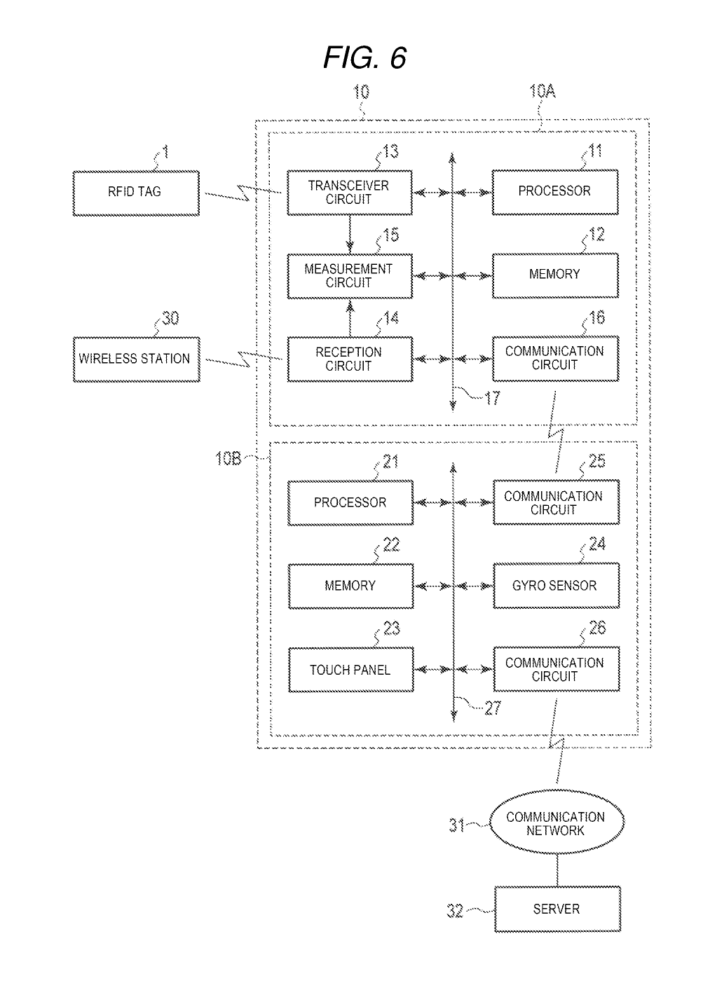

FIG. 6 is a block diagram illustrating an electrical configuration of the inspection place search device 10. In FIG. 6, same reference numerals are given to the same elements as those illustrated in FIG. 5.

The communication unit 10A performs wireless communication with the RFID tag 1 and a wireless station 30.

The RFID tag 1 is attached to the inspection place such as a bridge or a tunnel which becomes a searching target in advance as described above. Although only a single RFID tag 1 is illustrated in FIG. 6, a large number of RFID tags 1 are typically attached to a large number of inspection places, respectively. The RFID tag 1 operates when predetermined radio wave is received and transmits a tag ID which is a unique identification code. An RFID tag according to various standards can be suitably used as the RFID tag 1.

The wireless station 30 is installed in space (in the following, referred to as search target area) in which the inspection place is searched by using the inspection place search device 10. Although only a single wireless station 30 is illustrated in FIG. 6, a plurality of the wireless stations 30 are typically disposed in the search target area in a distributive manner. Although the wireless station 30 may be movable, the wireless station 30 is operated in a state of being fixed in principle. A single wireless station 30 may be used.

The wireless station 30 transmits a beacon signal which is unique and determined in advance wirelessly. The beacon signal may include a unique wireless station code for each wireless station 30 and may be one having an attribute of a beacon signal itself, for example, a frequency for each wireless station 30. A plurality of the wireless stations 30 transmit the beacon signal with substantially same strength. Transmission strength of the wireless station 30 is larger than transmission strength of the RFID tag 1. That is, a communication area of wireless station 30 is wider than the communication area of the RFID tag 1.

The communication unit 10A includes a processor 11, a memory 12, a transceiver circuit 13, a reception circuit 14, a measurement circuit 15, a communication circuit 16, and a system transmission path 17. The processor 11, the memory 12, the transceiver circuit 13, the reception circuit 14, the measurement circuit 15, and the communication circuit 16 are connected by the system transmission path 17. The system transmission path 17 includes an address bus, a data bus, a control signal line, and the like.

The processor 11 and the memory 12 are connected by the system transmission path 17 to constitute a computer for controlling the communication unit 10A.

The processor 11 corresponds to a nucleus part of the computer. The processor 11 realizes various functions as the communication unit 10A according to an operating system or an application program and controls respective components of the communication unit 10A.

The memory 12 corresponds to a nucleus part of a main storing portion of the computer. The memory 12 includes a nonvolatile memory region and a volatile memory region. The memory 12 stores the operating system or the application program in the nonvolatile memory region. When the memory 12 intends to store data needed for execution of processing for controlling respective components by the processor 11 in the volatile memory region, the memory 12 may use the volatile memory region as a work area in which data is suitably rewritten by the processor 11. A semiconductor memory is typically used as the memory 12. However, in addition to the semiconductor memory, another type of storage device such as an HDD (hard disc drive) may be included.

The transceiver circuit 13 radiates radio waves for operating the RFID tag 1. The transceiver circuit 13 receives a wireless signal transmitted by the RFID tag 1. That is, the transceiver circuit 13 is an example of a communication device that communicates with the RFID tag 1. The transceiver circuit 13 extracts a tag ID from the received wireless signal and notifies the measurement circuit 15 of the tag ID. The transceiver circuit 13 includes an antenna having directivity. The directivity has characteristics that have the maximum gain in a certain reference direction and that the gain is decreased as an angle to the reference direction is increased.

The reception circuit 14 receives a beacon signal transmitted by the wireless station 30. The reception circuit 14 determines a wireless station ID, which is an identification code unique to the wireless station 30 which has transmitted the beacon signal, based on the beacon signal. The reception circuit 14 notifies the measurement circuit 15 of the determined wireless station ID.

When the transceiver circuit 13 has received the wireless signal, the measurement circuit 15 measures reception strength of the wireless signal. When the reception circuit 14 has received the beacon signal, the measurement circuit 15 measures reception strength of the beacon signal. The measurement circuit 15 notifies the processor 11 of the measured reception strength together with the tag ID or the wireless station ID obtained from the same signal.

The communication circuit 16 performs wireless data communication between the communication unit 10A and the portable information terminal 10B. As the communication circuit 16, the existing device in compliance with, for example, Bluetooth (registered trademark) or Wi-Fi can be utilized.

The portable information terminal 10B includes a processor 21, a memory 22, a touch panel 23, a gyro sensor 24, a communication circuit 25, a communication circuit 26, and a system transmission path 27. The processor 21, the memory 22, the touch panel 23, the gyro sensor 24, the communication circuit 25, and the communication circuit 26 are connected by the system transmission path 27. The system transmission path 27 includes an address bus, a data bus, a control signal line, and the like.

The processor 21 and the memory 22 are connected by the system transmission path 27 to constitute a computer for controlling the portable information terminal 10B.

The processor 21 corresponds to a nucleus part of the computer. The processor 21 realizes various functions as the portable information terminal 10B according to an operating system or an application program and controls respective components of the portable information terminal 10B.

The memory 22 corresponds to a nucleus part of a main storing portion of the computer. The memory 22 includes a nonvolatile memory region and a volatile memory region. The memory 22 stores the operating system or the application program in the nonvolatile memory region. One of the application programs stored in the memory 22 is a control program for control processing which will be described. When the memory 22 intends to store data needed for execution of processing for controlling respective components by the processor 21 in the volatile memory region, the memory 22 uses the volatile memory region as a work area in which data is suitably rewritten by the processor 21. A semiconductor memory is typically used as the memory 22. However, in addition to the semiconductor memory, another type of storage device such as an HDD (hard disc drive) may be included.

The touch panel 23 functions as an input device and a display device of the portable information terminal 10B.

The gyro sensor 24 detects a direction of the portable information terminal 10B. In a state where the portable information terminal 10B is attached to the communication unit 10A, a relative relationship between a direction of the antenna included in the transceiver circuit 13 and the direction of the portable information terminal 10B is not changed. Accordingly, the gyro sensor 24 detects the direction of the antenna included in the transceiver circuit 13. That is, the gyro sensor 24 is an example of a detection unit.

The communication circuit 25 performs wireless data communication between the communication unit 10A and the portable information terminal 10B. That is, the communication circuit 25 communicates with the communication circuit 16 and can use the existing device in compliance with the same standard as that the communication circuit 16 complies.

The communication circuit 26 performs data communication through the communication network 31. The communication network 31 includes, for example, a mobile network. As the communication circuit 26, the existing device for communicating with the mobile network can be utilized. One of the counterparts subjected to data communication through the communication network 31 by the communication circuit 26 is a server 32.

The server 32 stores place data and association data in a storage device which is internally or externally provided. The server 32 answers various inquiries from the portable information terminal 10B based on the place data and association data.

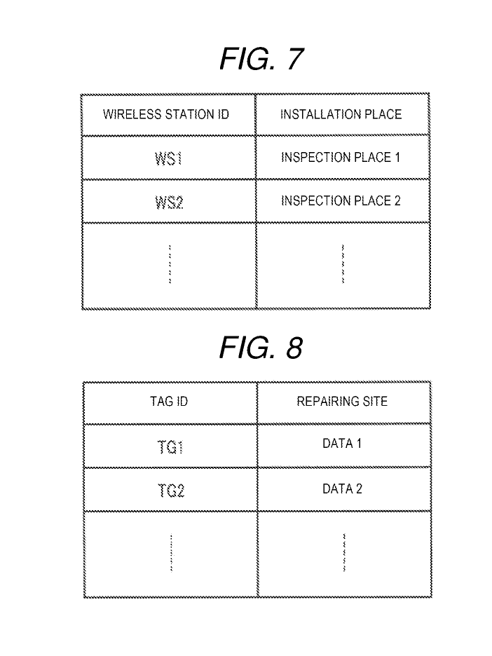

FIG. 7 is a diagram illustrating an example of place data. As illustrated in FIG. 7, the place data is a set of data records obtained by associating a wireless station ID with an installation place. The installation place is data by which a place, where the wireless station 30 identified by the wireless station ID associated in the same data record, is represented by a representation format capable of being recognized by a user. The place data is updated based on an operation by the worker or the like, as part of installation work of the wireless station 30. The representation format of the installation place illustrated in FIG. 7 is an example and which representation format is to be used for representing the installation place is optional.

FIG. 8 is a diagram illustrating an example of association data. As illustrated in FIG. 8, association data is a set of data record obtained by associating, for example, a tag ID, data of a repairing site, marking data, a photograph of the part thereof, records of content repairs, and the like of the site for which it is determined that mending is needed. In the data record of association data, data, which is obtained by associating the tag ID of the RFID tag attached to the inspection place in the search area with marking data, the photograph of the part thereof, records content repairs, and the like of the inspection place to which the RFID tag identified by the tag ID is attached, is described in principle.

Incidentally, the communication unit 10A and the portable information terminal 10B may be transferred to the user as a set and the communication unit 10A and the portable information terminal 10B may be individually transferred to the user. The application program may be stored in the memories 12 and 22 at the time-point when the communication unit 10A and the portable information terminal 10B are transferred to the user and may be written into the memories 12 and 22 by the operation of the user after the transfer of the communication unit 10A and the portable information terminal 10B. In the latter case, the application program may be recorded in a removable recording medium such as a magnetic disk, a magneto-optical disk, an optical disk, a semiconductor memory, or the like and otherwise, may be transferred to the user by an arbitrary method such as a method using a network.

Next, description will be made on operations of a case where work such as mending is performed on an inspection place of a structure such as a plate girder bridge using the inspection place search device 10 configured as described above. The operator turns the light 8 provided in the communication unit 10A of the inspection place search device 10 on to illuminate the periphery in a work site during work such as mending of the inspection place of the structure such as the plate girder bridge. In this case, even when the work site is wide, when illumination light from the light 8 reaches, the retro-reflective material 3 of the RFID tag 1 reflects illumination light from the light 8. For that reason, the operator is able to simply check a position of the RFID tag 1. When position of the RFID tag 1 is visually checked, the operator goes near the RFID tag 1 toward the direction of the RFID tag 1. When the light 8 is not included in the RFID reader 7 of the communication unit 10A, illumination light such as a flashlight may be utilized.

Reading of the RFID tag 1 is started by the RFID reader 7 of the communication unit 10A when it comes closer to a part near (roughly within 2 m) the retro-reflective material 3 of the RFID tag 1 at the target position. When an ID of the RFID tag 1 with the retro-reflective material 3 is read, the ID is displayed on a screen 18 of the portable information terminal 10B. In this case, when reference for the ID is made to the server 32 on cloud by a communication network 31 of a mobile telephone network such as LTE (registered trademark) (Long Term Evolution) provided in the portable information terminal 10B, a picture photographed during inspection or information such as contents of repairs are downloaded and displayed on the screen 18 of the portable information terminal 10B. When the plurality of RFID tag 1 with the retro-reflective material are present in nearby, the operation described above is repeated.

In the RFID tag 1 of the present embodiment having the configuration as described above, the RFID tag main body 2 in which the RFID chip 5 and the antenna 6 are disposed on a holding member 4 and the retro-reflective material 3 mounted on the RFID tag main body 2 are included. For that reason, during work such as mending of the inspection place of the structure such as a bridge or a tunnel, the operator turns the light 8 onto illuminate the periphery in the work site so as to make it possible to grasp remotely the position of the RFID tag 1 by reflection light of the retro-reflective material 3 being integrated with the RFID tag main body 2. Accordingly, in a state where the operator approaches to a part (roughly 2 m) close to the retro-reflective material 3 of the target RFID tag 1, it is possible to efficiently read information of the RFID tag 1 by the RFID reader 7 from the vicinity of the RFID tag 1. As a result, when the inspection site is checked while referencing the drawing having the contents recorded therein and checks the contents of repairs in the metal structure such as the plate girder bridge (abut bridge), it is possible to efficiently read the RFID tag 1 attached to the inspection site and to provide the RFID tag 1 from which necessary information can be acquired.

Like the modification example illustrated in FIG. 4, the RFID tag main body 2 and the retro-reflective material 3 of the RFID tag 1 may be disposed to be aligned on the same plane.

### Second Embodiment

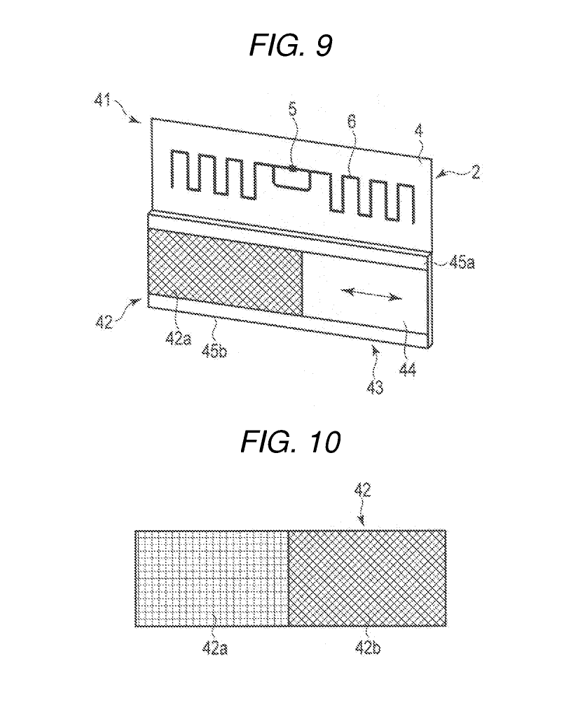

FIG. 9 and FIG. 10 illustrate a second embodiment. FIG. 9 is a perspective view illustrating an RFID tag 41 according to a second embodiment. In FIG. 9 and FIG. 10, the same elements as those of FIG. 1 to FIG. 8 are assigned same reference numerals and descriptions thereof will be omitted.

The RFID tag 41 of the present embodiment may be provided with the retro-reflective portion 42 disposed to be aligned on the same plane as the RFID tag main body 2, next to the RFID tag main body 2 and at the lower side the RFID tag main body 2 in FIG. 9. In the retro-reflective portion 42, as illustrated in FIG. 10, retro-reflective materials having a plurality of different display colors, in the present embodiment, retro-reflective materials (first retro-reflective material 42a and second retro-reflective material 42b) of two colors are disposed to be aligned laterally. Here, for example, the first retro-reflective material 42a is red and the second retro-reflective material 42b is white.

Furthermore, the retro-reflective portion 42 includes a display color selection unit 43 that selects a display color of the retro-reflective portion 42. The display color selection unit 43 includes a light shielding plate 44 which is movable in a direction parallel to the retro-reflective portion 42 (first retro-reflective material 42a and second retro-reflective material 42b) having a plurality of colors. The light shielding plate 44 is configured to be slidable in the right and left direction in FIG. 9 along a pair of guide members 45a and 45b disposed on the upper and lower portions of a reflecting surface side of a portion juxtaposed with the first retro-reflective material 42a and the second retro-reflective material 42b. The light shielding plate 44 is moved rightward and leftward along the guide members 45a and 45b so as to make it possible to selectively expose one of the first retro-reflective material 42a and the second retro-reflective material 42b. With this, the display color of the retro-reflective portion 42 can be selected.

Next, a method for finding a target RFID tag 41 in a state where RFID tags 41 of the present embodiment are attached to a structure such as the plate girder bridge will be described.

First, when the RFID tag 41 is intended to be attached to a metal structure, the RFID tag 41 is fixed by an adhesive tape with a spacer such as styrene foam held between the RFID tag 41 and the metal structure (not illustrated). This is because when the antenna 6 of the RFID tag main body 2 approaches metal, the antenna 6 does not function as an antenna. Furthermore, the RFID tag capable of being attached to a metallic surface and the retro-reflective portion 42 may be combined. In this case, for example, the light shielding plate 44 is moved to a position at which the light shielding plate 44 is superposed on the second retro-reflective material 42b as illustrated in FIG. 9 and this corresponds to a state where the first retro-reflective material 42a is exposed, that is, red color is reflected.

Next, the operator turns the light 8 provided in the communication unit 10A of the inspection place search device 10 on to illuminate the periphery in a work site such as mending of the inspection place of the structure such as the plate girder bridge, as illustrated in FIG. 3. In this case, in the present embodiment, since the first retro-reflective material 42a of the RFID tag 41 reflects red illumination light, the operator is able to check a position of the RFID tag 41 visually and simply. When position of the RFID tag 41 is visually checked, the operator goes near the RFID tag 41 toward the direction of the RFID tag 41. When the light 8 is not included in the RFID reader 7 of the communication unit 10A, illumination light such as a flashlight may be utilized.

Reading of the RFID tag 41 is started by the RFID reader 7 of the communication unit 10A when it comes closer to a part near (roughly within 2 m) the target RFID tag 41 with the retro-reflective material. When an ID of the RFID tag 41 is read, the ID is displayed on a screen 18 of the portable information terminal 10B. In this case, when reference for the ID is made to the server 32 on cloud by a communication network 31 of a mobile telephone network such as LTE (registered trademark) (Long Term Evolution) provided in the portable information terminal 10B, a picture photographed during inspection or information such as contents of repairs are downloaded and displayed on the screen 18 of the portable information terminal 10B. When the plurality of RFID tag 41 with the retro-reflective material are present in nearby, the operation described above is repeated.

When mending of the repairing site is completed, the light shielding plate 44 is moved to a position at which the light shielding plate 44 is superposed on the first retro-reflective material 42a and is set to a state where the second retro-reflective material 42b is exposed, that is, white color is reflected. With this, although the RFID tags 41 that reflects red and white are mixed in the construction site, red indicates before-repair and white indicates repair-completion and thus, the operator can select the RFID tag 41 according to a purpose.

### Third Embodiment

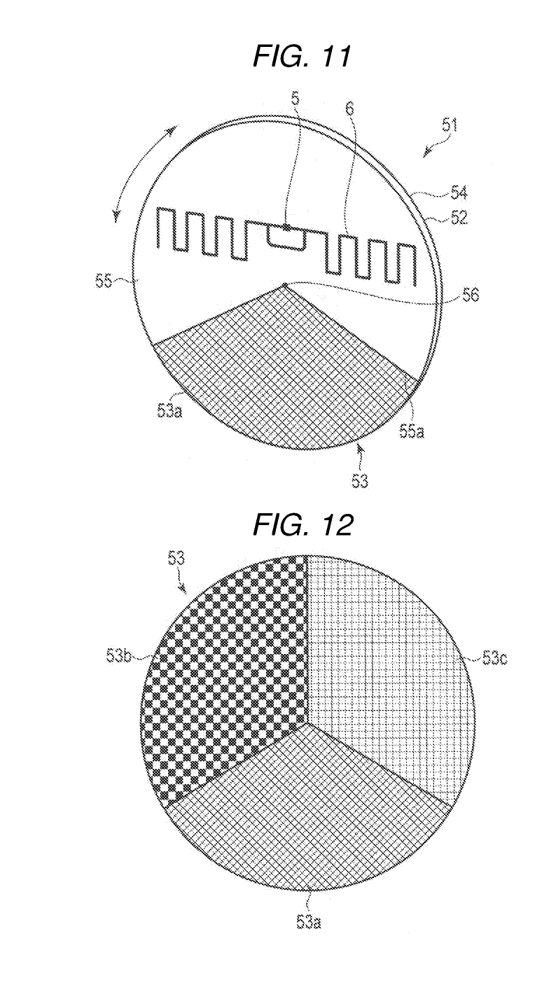

FIG. 11 and FIG. 12 indicate a third embodiment. FIG. 11 is a perspective view of an RFID tag 51 according to a third embodiment. In FIG. 11 and FIG. 12, the same elements as those of FIG. 1 to FIG. 8 are assigned same reference numerals and descriptions thereof will be omitted.

The RFID tag 51 of the present embodiment includes a disk shaped RFID tag main body 52 and a circular retro-reflective portion 53 mounted on the RFID tag main body 52. The RFID tag main body 52 is provided with a disk shaped holding member (sheet base material) 54. The RFID chip 5 and the antenna 6 are disposed on the holding member 54.

The circular retro-reflective portion 53 is formed in a circular shape having a diameter equal to that of the circular shape of the disk shaped holding member 54 of the RFID tag main body 52. In the retro-reflective portion 53, as illustrated in FIG. 12, retro-reflective materials having a plurality of different display colors, in the present embodiment, retro-reflective materials (first retro-reflective material 53a, second retro-reflective material 53b, third retro-reflective material 53c) of three colors are disposed at equal intervals in the circumferential direction. Fan shapes of the first to third retro-reflective materials 53a to 53c are formed to have the same size of the center angle of 120°. Here, for example, the first retro-reflective material 53a is red, the second retro-reflective material 53b is white, and the third retro-reflective material 53c is yellow.

Furthermore, a light shielding plate 55 which is nearly circular and provided with a fan shaped opening portion 55a is provided on a reflecting surface side of the first to third retro-reflective materials 53a to 53c. The fan shaped opening portion 55a is formed to have the same size as those of the first to third retro-reflective materials 53a to 53c. The light shielding plate 55 is configured to be rotatable around a rotation shaft 56 disposed at the center of the circle.

The light shielding plate 55 rotates around the rotation shaft 56 so as to make it possible to selectively expose any of the first to third retro-reflective materials 53a to 53c so as to make it possible to selectively expose any one of the first to third retro-reflective materials 53a to 53c from the fan shaped opening portion 55a.

In the present embodiment, as illustrated FIG. 11, the retro-reflective portion 53 and the light shielding plate 55 are disposed to be superposed and laminated on the surface of the RFID tag main body 52. Accordingly, although the RFID chip 5 and the antenna 6 are not seen from the reflecting surface side of the retro-reflective portion 53, as illustrated FIG. 11, the RFID chip 5 and the antenna 6 are displayed on the reflecting surface side of the retro-reflective portion 53 in a superposing manner for explanation.

Next, a method for finding a target RFID tag 51 with the retro-reflective material in a state where RFID tags 51 with the retro-reflective material of the present embodiment are attached to a structure such as the plate girder bridge will be described.

First, when the RFID tag 51 with the retro-reflective material is intended to be attached to a metal structure, the RFID tag 51 is fixed by an adhesive tape with a spacer such as styrene foam held between the RFID tag 51 and the metal structure (not illustrated). This is because when the antenna 6 of the RFID tag main body 52 approaches metal, the antenna 6 does not function as an antenna. Furthermore, the RFID tag 51 capable of being attached to a metallic surface and the retro-reflective portion 53 may be combined. In this case, the light shielding plate 55 is rotated to a position at which the first retro-reflective material 53a of red is exposed.

Next, the operator turns the light 8 provided in the communication unit 10A of the inspection place search device 10 on to illuminate the periphery in a work site such as mending of the inspection place of the structure such as the plate girder bridge, as illustrated in FIG. 3. In this case, in the present embodiment, since the first retro-reflective material 53a of the RFID tag 51 with the retro-reflective material reflects red illumination light, the operator is able to check a position of the RFID tag 51 visually and simply. When position of the RFID tag 51 is visually checked, the operator goes near the RFID tag 51 toward the direction of the RFID tag 51. When the light 8 is not included in the RFID reader 7 of the communication unit 10A, illumination light such as a flashlight may be utilized.

Reading of the RFID tag 51 is started by the RFID reader 7 of the communication unit 10A when it comes closer to a part close to (roughly within 2 m) the target RFID tag 51 with the retro-reflective material. When an ID of the RFID tag 51 is read, the ID is displayed on a screen 18 of the portable information terminal 10B. In this case, when reference for the ID is made to the server 32 on cloud by a communication network 31 of a mobile telephone network such as LTE (registered trademark) (Long Term Evolution) provided in the portable information terminal 10B, a picture photographed during inspection or information such as contents of repairs are downloaded and displayed on the screen 18 of the portable information terminal 10B. When the plurality of RFID tag 51 with the retro-reflective material are present in nearby, the operation described above is repeated.

When mending of the repairing site is completed, the fan shaped opening portion 55a of the light shielding plate 55 is rotated to a state where the second retro-reflective material 53b of white is exposed. When a re-inspection is needed a few years later, the fan shaped opening portion 55a of the light shielding plate 55 is rotated such that the third retro-reflective material 53c of yellow is exposed. With this, although the RFID tags 51 with the retro-reflective material that reflects red, white, and yellow are mixed in the construction site, red indicates before-repair, white indicates repair-completion, and yellow indicates progress observation thus, the operator can select the RFID tag 51 with the retro-reflective material according to a purpose.

### Fourth Embodiment

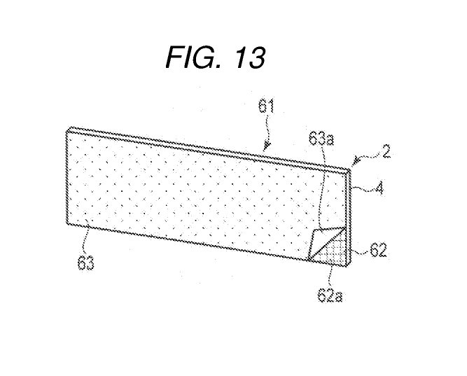

FIG. 13 is a perspective view for explaining a use state of an RFID tag 61 with the retro-reflective material according to a fourth embodiment. In FIG. 13, the same elements as those of FIG. 1 to FIG. 8 are assigned same reference numerals and descriptions thereof will be omitted. In the RFID tag 61 of the present embodiment, the RFID chip 5 and the antenna 6 are disposed on the holding member 4 of the RFID tag main body 2 and a retro-reflective material 62 of white is disposed thereon. Furthermore, for example, a color film 63 of red is attached to a reflecting surface of the retro-reflective material 62. The color film 63 is structured to be peeled off from the retro-reflective material 62 by pulling up a peeling portion 63a.

Next, a method for finding a target RFID tag 61 with the retro-reflective material in a state where RFID tags 61 with the retro-reflective material of the present embodiment are attached to a structure such as the plate girder bridge will be described.

First, when the RFID tag 61 with the retro-reflective material is intended to be attached to a metal structure, the RFID tag 61 is fixed by an adhesive tape with a spacer such as styrene foam held between the RFID tag 61 and the metal structure (not illustrated). This is because when the antenna 6 of the RFID tag main body 2 approaches metal, the antenna 6 does not function as an antenna. Furthermore, the RFID tag 61 capable of being attached to a metallic surface and the retro-reflective material 62 maybe combined. In this case, the retro-reflective material 62 is in a state of reflecting a color (for example, red) of the color film 63.

Next, the operator turns the light 8 provided in the communication unit 10A of the inspection place search device 10 on to illuminate the periphery in a work site such as mending of the inspection place of the structure such as the plate girder bridge, as illustrated in FIG. 3. In this case, in the present embodiment, since the RFID tag 61 with the retro-reflective material reflects red illumination light, the operator is able to check a position of the RFID tag 61 visually and simply. When position of the RFID tag 61 is visually checked, the operator goes near the RFID tag 61 toward the direction of the RFID tag 61. When the light 8 is not included in the RFID reader 7 of the communication unit 10A, illumination light such as a flashlight may be utilized.

Reading of the RFID tag 61 is started by the RFID reader 7 of the communication unit 10A when it comes closer to a part close to (roughly within 2 m) the target RFID tag 61 with the retro-reflective material. When an ID of the RFID tag 61 is read, the ID is displayed on a screen 18 of the portable information terminal 10B. In this case, when reference for the ID is made to the server on cloud by a communication network 31 of a mobile telephone network such as LTE (registered trademark) (Long Term Evolution) provided in the portable information terminal 10B, a picture photographed during inspection or information such as contents of repairs are downloaded and displayed on the screen 18 of the portable information terminal 10B. When the plurality of RFID tag 61 with retro-reflective material are present in nearby, the operation described above is repeated.

When mending of the repairing site is completed, the color film 63 is peeled off with a portion of the peeling portion 63a.

With this, the retro-reflective material 62 of the RFID tag 61 becomes in a state where white is reflected. In this state, although the RFID tags 61 with the retro-reflective material that reflects red and white are mixed in the construction site, red indicates before-repair and white indicates repair-completion and thus, the operator can select the RFID tag 61 with the retro-reflective material according to a purpose.

According to the embodiments, it is possible to grasp remotely the position of the RFID tag by reflection light of the retro-reflective material being integrated with the RFID tag and it is possible to efficiently read information of the RFID tag by the RFID reader from the vicinity of the RFID tag. It is possible to specify the RFID tag to be searched through selection of the retro-reflective material having a plurality of colors by the light shielding plate. With this, it is possible to provide an RFID tag which is attached to an inspection site and is capable of being efficiently searched for and from which necessary information is capable of being acquired, when the inspection site is checked while referencing the drawing within a metal structure such as a plate girder bridge.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An RFID tag comprising:
an RFID tag main body comprising an RFID chip and an antenna disposed on a base material; and
a retro-reflective material mounted on the RFID tag main body.

2. The RFID tag according to claim 1,
wherein the retro-reflective material is superposed on the RFID tag main body.

3. The RFID tag according to claim 1,
wherein the retro-reflective material is aligned on the same plane as the RFID tag main body.

4. The RFID tag according to claim 1,
wherein the retro-reflective material comprises
a retro-reflective portion having a plurality of different display colors, and
a display color selection unit that selects a display color of the retro-reflective portion, and
the display color selection unit comprises a light shielding plate movable in an aligning direction of the retro-reflective portion having a plurality of colors and moves the light shielding plate so as to make it possible to select the display color of the retro-reflective portion.

5. The RFID tag according to claim 4,
wherein the retro-reflective portion has a first color and a second color.

6. The RFID tag according to claim 1,
wherein the retro-reflective material reflects illumination light.

7. The RFID tag according to claim 1,
wherein the retro-reflective material comprises a peelable color film on a reflecting surface.

8. An RFID system comprising:
an RFID tag comprising
an RFID tag main body comprising an RFID chip and an antenna disposed on a base material, and
a retro-reflective material mounted on the RFID tag main body;
a wireless station configured to transmit a beacon signal; and
an inspection place search device.

9. The RFID system according to claim 8, comprising a plurality of RFID tags and a plurality of wireless stations.

10. The RFID system according to claim 9,
wherein the plurality of wireless stations are configured to transmit beacon signals of substantially similar strength.

11. The RFID system according to claim 8,
wherein the retro-reflective material is aligned on the same plane as the RFID tag main body.

12. The RFID system according to claim 8,
wherein the retro-reflective material comprises
a retro-reflective portion having a plurality of different display colors, and
a display color selection unit that selects a display color of the retro-reflective portion, and
the display color selection unit comprises a light shielding plate movable in an aligning direction of the retro-reflective portion having a plurality of colors and moves the light shielding plate so as to make it possible to select the display color of the retro-reflective portion.

13. The RFID system according to claim 12,
wherein the retro-reflective portion has a first color and a second color.

14. The RFID system according to claim 8,
wherein the retro-reflective material comprises a peelable color film on a reflecting surface.

15. The RFID system according to claim 8,
wherein the inspection place search device comprises a processor, a memory, a transceiver circuit, a reception circuit, a measurement circuit, a communication circuit, and a system transmission path.

16. A method for using an RFID tag, comprising:
using light to visually identify the RFID tag, the RFID tag comprising a main body comprising an RFID chip and an antenna disposed on a base material, and a retro-reflective material mounted on the RFID tag main body;
reading an ID of the RFID tag using an inspection place search device; and
wirelessly communicating with a server to obtain contents of a repair record.

17. The method according to claim 16, further comprising:
attaching a plurality of RFID tags to portions of a bridge.

18. The method according to claim 16, further comprising:
attaching a plurality of RFID tags to portions of a tunnel.

19. The method according to claim 16,
wherein reading the ID of the RFID tag is carried out wirelessly.

20. The method according to claim 16,
wherein the inspection place search device projects light to visually identify the RFID tag.
